(19) United States
(12) Patent Application Publication
(10) Pub. No.: US 2002/0152130 A1
(43) Pub. Date: Oct. 17, 2002

(54) Method for conducting an on-line raffle session

(76) Inventor: Darwin Aldis Salls, Ocala, FL (US)

Correspondence Address: Darwin Aldis Salls, 5861 S.W. 103rd Street Road, P.O. Box 770126, Ocala, CA, 34476-9375, US

(21) Appl. No.: 09/836,619

(22) Filed: Apr. 16, 2001

(51) Int. Cl. G06F 17/60

(52) U.S. Cl. 705/26

(57) ABSTRACT

The invention presents a method for conducting an on-line raffle session, where an article owner 50 participates in the on-line raffle session by submitting an article 45 via remote computer 31 or carrier service, to a central raffle company 16. The on-line raffle company places the article in the company's data base 17 and the on-line raffle directory 24. Accordingly, the method of raffling the article is conducted over a computer network 15, that includes a central computer 19, a number of remote computers 31, communication lines 30, connecting the remote computers 31 to the central computer 19. Ticket purchasers 56 purchase raffle tickets via on-line over the Internet by remote computers 31. Each ticket purchaser 56 registers information and opens an account by remote computer 31 linked with the raffle company computer 27 of the account division 26. Account information is filed in the ticket purchaser data base 21. The ticket purchaser 56 views the articles 45 on-line in the raffle company's directory 24, and purchases tickets using the raffle entry form 67 template with a credit card debit card or other means of payment. When the article being raffled reaches 100% raffle price threshold, the raffle closes and the ticket numbers are submitted to a secure electronic ticket number selector 23, which randomly chooses a winning ticket number.

### STATEMENT REGARDING FEDERALLY SPONSERED RESEARCH OR DEVELOPMENT

Applicant has not recieved any federally sponsored research or development assistance.

### REFERENCE TO A MICROFICHE APPENDIX

Applicant does not have a microfiche appendix.

### BACKGROUND OF THE INVENTION

1. Field of the Invention

The present invention relates generally to conducting an on-line raffle, in particular, where the article or property owner participates by submitting an article or property, via the Internet or carrier, to a central on-line raffle service. The raffle service then raffles the article or property and pays the owner his/her full asking price for the article raffled.

2. Description of Related Art

In general, a raffle is a popular and exciting method for a person or group of people to purchase tickets at a low price, for a chance to win an item of greater value. Traditionally, raffles are held by schools, charities, and other non-profit organizations to raise funds for their projects. Articles are usually donated to these non-profit organizations by individuals who usually receive tax benefits, by writing-off the value of the article or property. Recently, there have been raffles conducted on-line over the Internet by these non-profit organizations, wherein, a larger audience is reached to increase ticket sales and raise more funds for these non-profit organizations. Much of the merchandise raffled by these non-profit organizations range from a few hundred dollars to over ten thousand dollars.

In many jurisdictions, raffles are considered gaming and are restricted by government regulations with the exception of non-profit organizations, which are regulated by taxing authorities. Currently, there are no on-line restrictions that prevent a for-profit organization from existing, notwithstanding individual state, federal, and country laws and regulations.

The present invention allows an individual or agent to participate by submitting an item, article, or property (herein article) to the raffle service for raffling. The article and registrant are registered with the raffle service, who places the article and the registrant into their data base. The articles are then raffled on-line over the Internet. The article owner receives full asking price without having to pay a commission. The raffle service attaches a commission to the article owner's full asking price, then sets a price per ticket amount and, quantity of raffle tickets to be sold, to reach the full raffle price. Once the threshold raffle price is reached, a drawing is held by electronic means to determine a winning ticket number. Once the winning ticket holder is notified, the article is transferred to the winner and the article owner receives his/her full asking price.

### OBJECTS AND ADVANTAGES OF THE INVENTION

Accordingly, it is the object of the present invention to provide a method for conducting an on-line raffle session that permits article owners or agents to participate by submitting articles to the on-line raffle service and receive their full asking price, without paying a commission. It is another object of the invention to greatly increase the number of article owner registrants, and ticket purchasers, participating in the on-line raffle service, by having the raffle over the Internet. It is further an object of the invention to display updated raffle information, in real-time for article registrants and ticket purchasers convenience. These and other objects and advantages of the present invention will become more apparent after consideration of the ensuing descriptions and accompanying drawings.

### SUMMARY OF THE INVENTION

The invention presents a method for conducting an on-line raffle session by offering a service to article owners or agents to raffle these articles on-line over the Internet, and to ticket purchasers who purchase a ticket, for a chance to win the article. The article owners or agents register their articles on-line, or by carrier service, wherein, each article is raffled on-line to registered ticket purchasers, through a computer network that includes a central computer, a number of remote computers, and communication lines connecting the remote computers to the central computer. In a preferred embodiment, the central computer is a world-wide-web server and the communication lines is the Internet, that connect the article owners remote computers, and the ticket purchasers remote computers, to the world-wide-web server.

The method includes the step of registering an article in the central computer by a registrant, and registering multiple ticket purchasers in the central computer. The article owner can be an individual, organization, institution, government agency, or group of individuals formed purely for the purpose of submitting an article or articles to be raffled. The raffle ticket purchaser can be an individual, organization, institution, government agency, or group of individuals formed purely for the purpose of purchasing one or more raffle tickets. The article owner or agent registrant and article are tracked by the central computer. The raffle ticket purchaser and ticket purchases are also tracked by the central computer. The method also includes the step of receiving in the central computer, raffle ticket purchases entered from remote computers or carrier service. Each raffle ticket purchased for a particular article, is added to the total tickets purchased for the particular article. When the total ticket sales reach the threshold amount, the raffle is closed-out and the ticket numbers are submitted to an electronic ticket number selector, to select a winning ticket number. The total number of tickets sold per raffled article, is preferably displayed on remote computers as percentages, instead of number of tickets sold, in order to keep the total raffle price and article price confidential. After each ticket is sold, the information is updated in real-time for the article owner and ticket purchaser convenience.

In a particularly advantageous embodiment, the method includes the step of creating article owners and ticket purchaser accounts for each article, individual, or entity, in an account computer, networked to the central computer. Each account includes the name, identification number, address, financial account number, credit card or debit card number, checking or savings account number, if applicable. Additionally, the article owner's account includes information pertaining to the article, that includes: an identification number; description, photograph, graphical picture, and/or a select media type that includes video imaging; location; restrictions for new owners; a contract, and; a disclosure statement.

When a winning ticket is selected electronically, the winning ticket number is matched to the ticket purchaser data base for all relevant information to notify the winner of the article. The article is transferred to the winner of the raffle and the article owner is paid full asking price, from the raffle proceeds.

### BRIEF DESCRIPTION OF THE DRAWINGS

FIG. 1: is a block diagram illustrating a computer network according to a preferred embodiment of the invention.

FIG. 2: is a block diagram illustrating the creation of an article and registrant account according to a preferred embodiment of the invention.

FIG. 3: is a block diagram illustrating the creation of a raffle ticket purchaser account according to a preferred embodiment of the invention.

FIG. 4: is a sample article registrant account creation form as it appears on the screen of a remote computer of FIG. 2.

FIG. 5: is a sample of a raffle ticket purchaser account creation form as it appears on the screen of a remote computer of FIG. 3.

FIG. 6: is a sample article registrant account confirmation message as it appears on the screen of remote computer of FIG. 2.

FIG. 7: is a sample raffle ticket purchaser account confirmation message as it appears on the screen of a remote computer of FIG. 3.

FIG. 8: is a block diagram illustrating the process of a raffle ticket purchase according to a preferred embodiment of the invention.

FIG. 9: is a sample raffle entry form as it appears on the screen of a remote computer of FIG. 8.

FIG. 10: is a flow chart illustrating a method for conducting an on-line raffle session according to a preferred embodiment or the invention.

FIG. 11: is a flow chart illustrating the creation of a raffle ticket purchaser account (step 78 in FIG. 10).

FIG. 12: is a flow chart illustrating the creation of an article and registrant account (step 75 in FIG. 10).

FIG. 13: is a flow chart illustrating the execution of a raffle session (step 80 in FIG. 10).

FIG. 14: is a flow chart illustrating the processing of a winning raffle ticket number (step 84 in FIG. 10).

### DETAIL DESCRIPTION OF THE INVENTION

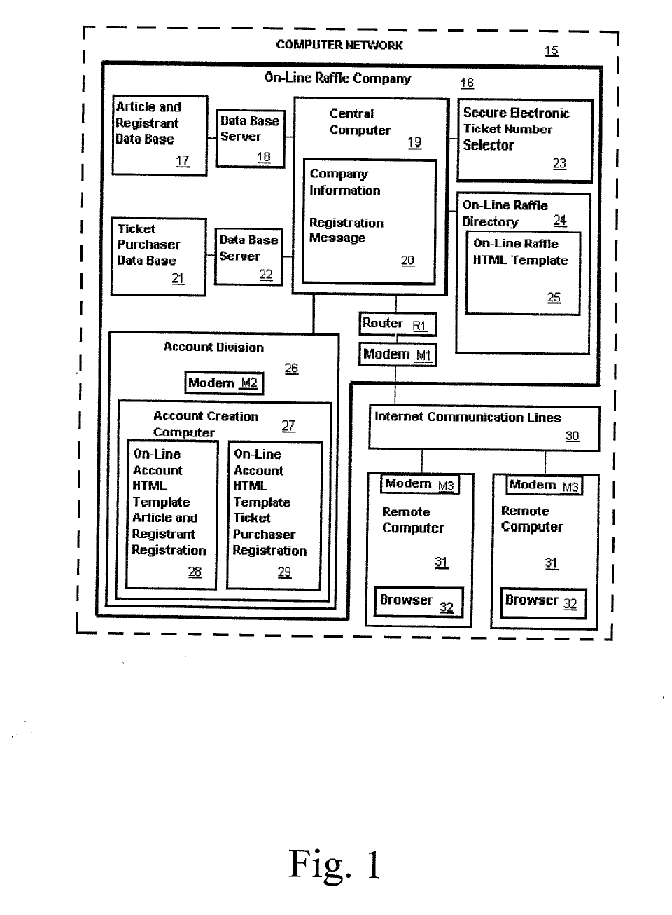

FIGS. 1 through 9, illustrate a preferred computer network for conducting an on-line raffle session according to the present invention. FIG. 1, the computer network 15 includes a central computer 19 of an on-line raffle company 16. Central computer 19 is connected to a data base server 18 serving an article and registrant data base 17 which is accessible to the central computer 19. Central computer 19 is also connected to a data base server 22 which serves the ticket purchaser data base 21 and is also accessible to the central computer 19. Central computer 19 contains general company information and a registration message 20. Central computer 19 is further networked to a secure electronic ticket number selector 23. The secure electronic ticket selector 23 exists in-company according to this particular network, however, it can be outsourced to limit potential abuse from employees. Central computer 19 is further networked to a router R1 and a modem M1 for connecting central computer 19 to communication lines 30. In the preferred embodiment, central computer 19 is a world-wide-web server machine and communication lines 30 is the Internet.

Network 15 further includes an account creation computer 27 of an account division 26. Although the preferred embodiment of on-line raffle company 16 has an account division 26, in-house, the account division 26 can be outsourced to an account company of the type that provides Internet users with secure accounts for performing on-line commerce. Account creation computer 27 has a modem M2 for connecting account creation computer 27 to communication lines 30.

Network 15, also includes a number of remote computers 31, each having a modem M3 for connecting the remote computers 31 to communication lines 30. For simplicity of illustration, only two remote computers 31 are illustrated in FIG. 1. It is to be understood, however, that any number of remote computers 31 can be included in the computer network 15 of the present invention. Further, the preferred embodiment utilizes modems and the Internet to network central computer 19, account creation computer 27, and remote computer 31. It will be apparent to one skilled in art that any type of connection, including a complete wireless system, may be used to network the computers. Specific techniques for networking computers are well known.

Each remote computer 31 has an Internet browser 32 for displaying web content in the form of Hyper Text Markup Language (HTML). Browser 32 allows remote computer 31 to access and display the content of an HTML template 25, residing in the on-line raffle directory 24, which resides in the central computer 19. HTML template 25 contains the main web pages displayed to on-line raffle ticket purchasers 56, articles 45, and registrants 50, on remote computers 31. Similarly, account creation computer 27 has dual on-line account HTML templates 28, 29 for article and registrant registration 28 and ticket purchaser registration 29, accessible by remote computer 31. In a particularly advantageous embodiment, templates 25, 28, 29 are secure HTML templates, and Internet browser 32 is a secure HTML compliant browser. Using secure HTML ensures confidentiality for the account, article registrant, and purchase transactions that will be described below.

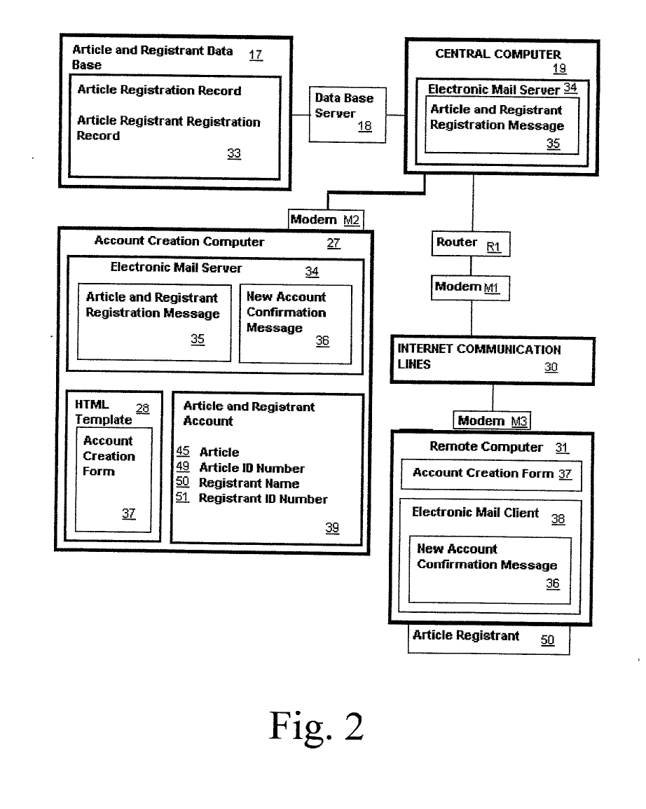

FIG. 2, illustrates the main components of a central computer 19, account creation computer 27, and remote computer 31, used in creation of an article and registrant account 39 as recorded in the article and registrant data base 17, as article and registrant registration record 33. An article registrant 50 remote computer 31 accesses on-line account HTML template 28 residing in account creation computer 27. Template 28 contains an account creation form 37 that is displayed on the screen of the article registrant 50 remote computer 31. Account creation computer 27 has an electronic mail server 34 for sending a new account confirmation message 36 to article registrant 50 remote computer 31. Remote computer 31 has an electronic mail client 38 for receiving and confirming new account confirmation message 36. Account creation computer 27 has storage capacity for storing an article and registrant account 39, that includes the article 45, article identification number 49, registrant 50, registrant identification number 51, and additional pertinent information about article 45 and registrant 50. Additionally, mail server 34 is capable of generating an article and registrant registration message 35 upon receipt of account confirmation from remote computer 31. Registration message 35 includes all the information from corresponding article and registrant account 39. Central computer 19 has an electronic mail server 34 for receiving the article and registrant registration message 35. Central computer mail server 34 is linked to the article and registrant data base 17 so that a corresponding registration record 33 is also created in the article and registrant data base 17 upon receipt of the registration message.

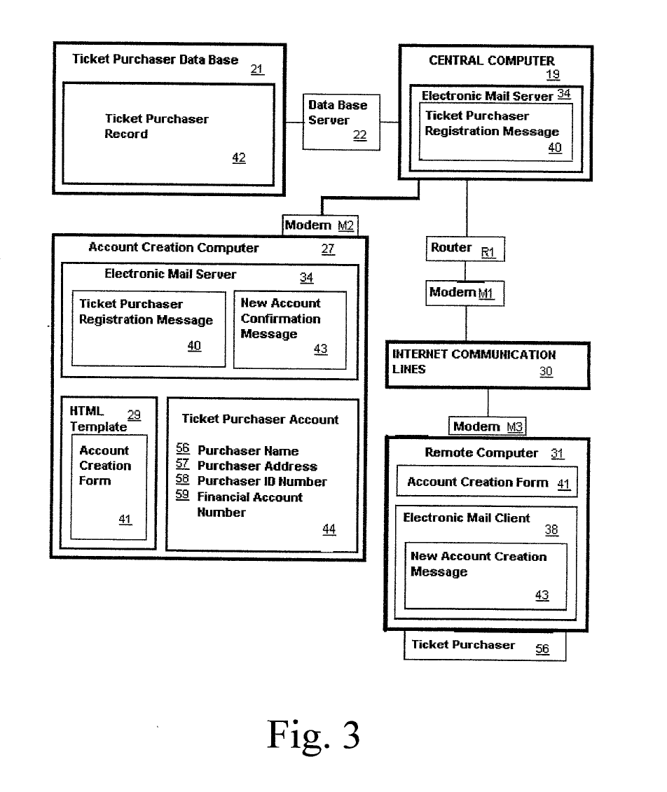

FIG. 3, illustrates the main components of central computer 19, account creation computer 27, and remote computer 31, used in creation of a ticket purchaser account 44 as recorded in the ticket purchaser data base 21 as a ticket purchaser record 42. A ticket purchaser 56 remote computer 31 accesses on-line account HTML template 29 residing in account creation computer 27. Template 29 contains an account creation form 41 which is displayed on the screen of the ticket purchaser 56 remote computer 31. Account creation computer 27 has an electronic mail server 34 for sending a new account confirmation message 43 to ticket purchaser 56 remote computer 31. Remote computer 31 has an electronic mail client 38 for receiving and confirming new account confirmation message 43. Account creation computer 27 has storage capacity for storing ticket purchaser account 44 that includes the purchaser name 56, purchaser address 57, purchaser identification number 58, and financial account number 59. Additionally, mail server 34 is capable of generating a ticket purchaser registration message 40 upon receipt of account confirmation from remote computer 31. Registration message 40 includes all information from the corresponding ticket purchaser account 44. Central computer 19 has an electronic mail server 34 for receiving the registration message 40. The central computer 19 mail server 34 is linked to the ticket purchaser data base 21 so that a corresponding ticket purchaser record is also created upon receipt of the registration message 40.

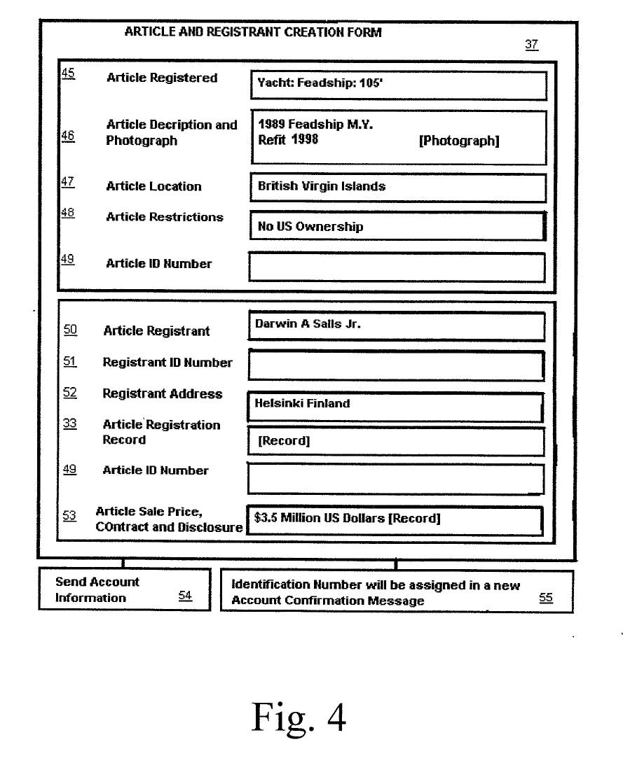

FIG. 4, illustrates a sample article and registrant account creation form 37. The article and registrant account creation form 37 has eleven fields corresponding to an article registered 45 and gives an example; article description and photograph 46 which shows an example and location for a photograph, graphical picture or even a video image for a virtual tour; article location 47 which gives an example; article restrictions 48 which gives an example; article identification number 49 which will be assigned by the central computer; article registrant 50 with an example; registrant identification number 51 which will be assigned by the central computer; registrant address 52 with an example; article registration record 33; article identification number 49 which will be assigned; article sale price 53 with an example. The article and registrant account creation form 37 also contains a button 54 advising the article registrant 50 to send the account information to the account creation computer 27, and a note 55 advising article registrant that the identification numbers will be assigned in a new account confirmation message 36.

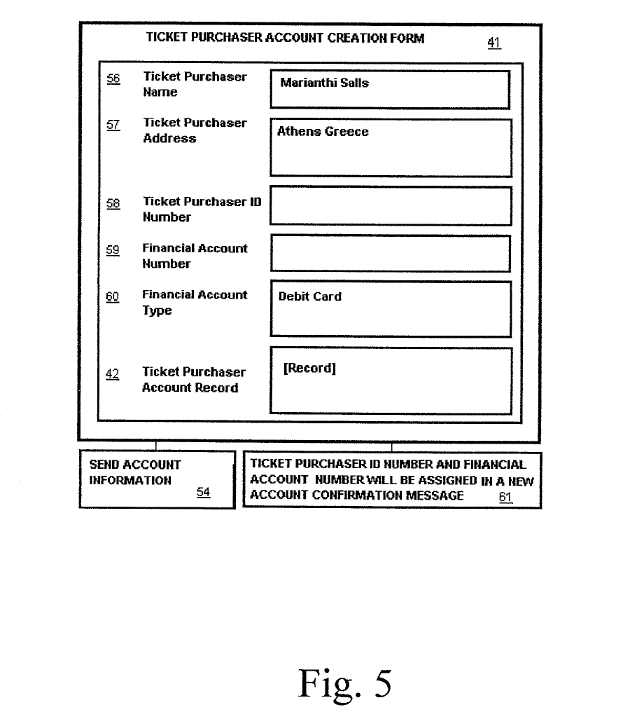

FIG. 5, illustrates a sample ticket purchaser account creation form 41. Ticket purchaser account creation form 41 has six fields corresponding a ticket purchaser name 56 with an example; ticket purchaser address 57 with an example; ticket purchaser identification number 58 which will be assigned by the central computer; financial account number 59 which will be a credit card, debit card or other assigned number; financial account type 60 with an example; ticket purchaser account record with no example. Ticket purchaser account creation form 41 also contains a note 61 advising the ticket purchaser that a ticket purchaser identification number 58 will be assigned in a new account confirmation message, as will be described below. Additionally, form 41 contains a button 54 for the ticket purchaser to press to send form 41 to account creation computer after completing the form.

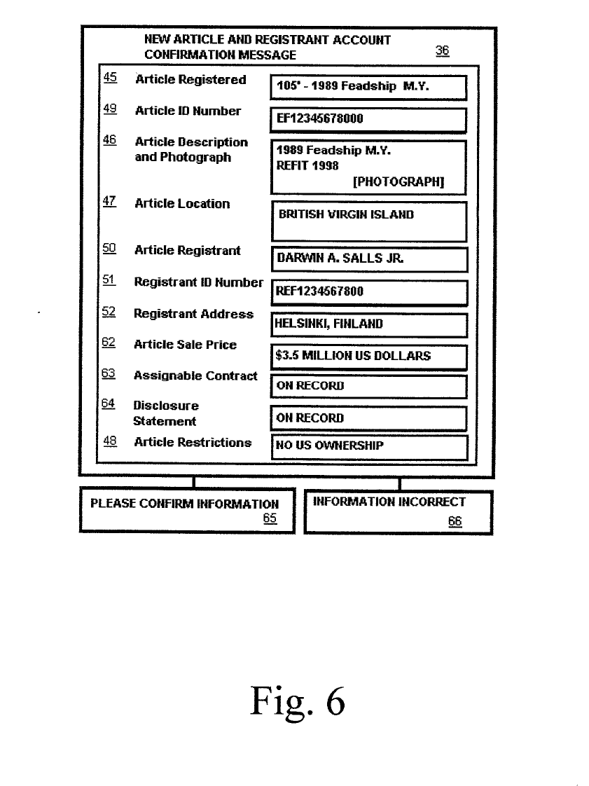

FIG. 6, illustrates a sample new article and registrant account confirmation message 36. Confirmation message 36 includes eleven fields corresponding to the article registered 45 which gives an example; article identification number 49 which has been assigned in an example; article description and photograph 46 which gives an example; article location 47 with an example; article registrant 50 with an example; registrant identification number 51 which has been assigned in the example; registrant address 52 which gives an example; article sale price 62 with an example; assignable contract 63 which the example states is on record; disclosure statment 64 which the example states is on record; article restrictions 48 with an example. Confirmation message 36 also has a button 65 for the registrant to confirm that all the information is correct. If the information is incorrect the registrant has another button 66 which will redirect the registrant back to the article and registrant account creation form to correct the error made in the account creation form.

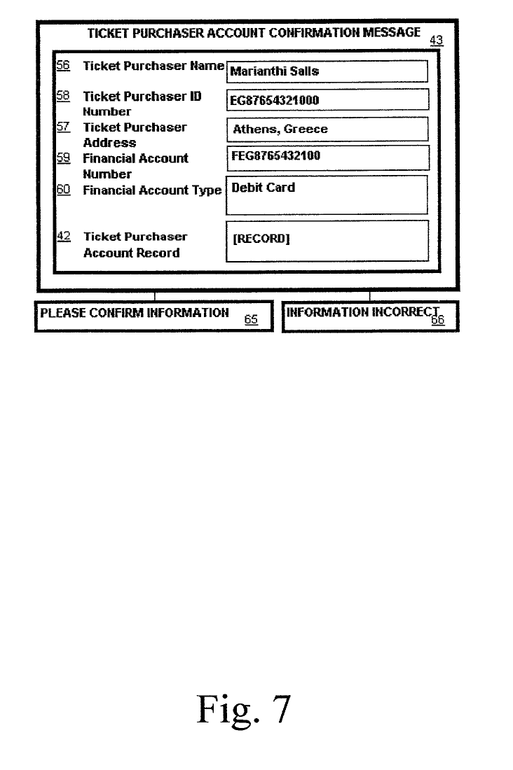

FIG. 7, illustrates a sample ticket purchaser account confirmation message 43. Message 43 includes six fields corresponding to the ticket purchaser name 56 which gives an example; ticket purchaser identification number 58 which gives an example that the central computer has assigned the number; ticket purchaser address 57 which gives an example; financial account number 59 which has been assigned in the example; financial account type 60 which gives an example; and ticket purchaser account record 42. Message 43 contains a button 65 to confirm the information and a button 66 if the information is incorrect which returns ticket purchaser to ticket purchaser account creation form 41 to correct the error.

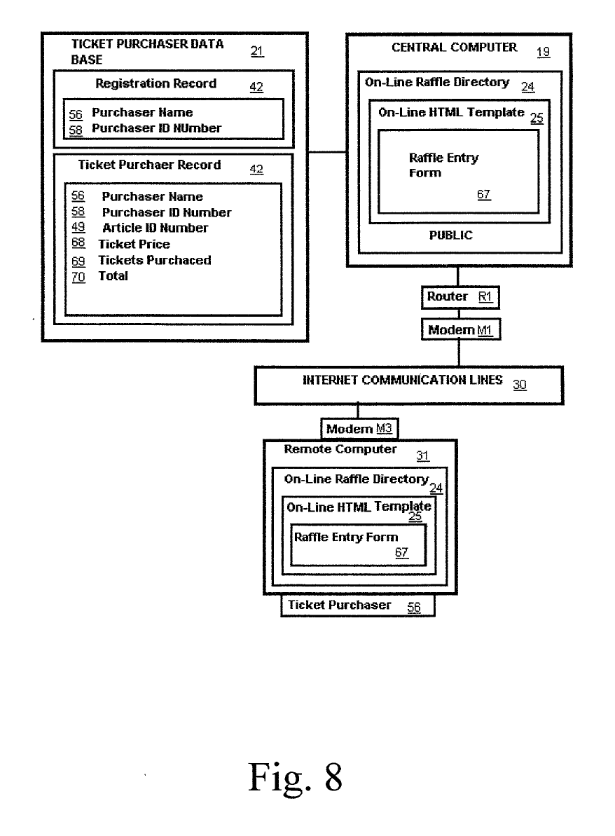

FIG. 8, illustrates the main components of central computer 19, ticket purchaser data base 21, and ticket purchaser 56 remote computer 31 used to submit and record ticket purchases from the article being raffled. The HTML template 25 residing in the on-line raffle directory 24 contains a raffle entry form 67. Raffle entry form 67 is displayed on the screen of remote computer 31 when ticket purchaser 56 accesses HTML template 25 through communication lines 30. The ticket purchaser data base 21 contains ticket purchaser's registration record 42 and ticket purchaser record 42 which records any purchases made by the ticket purchaser 56.

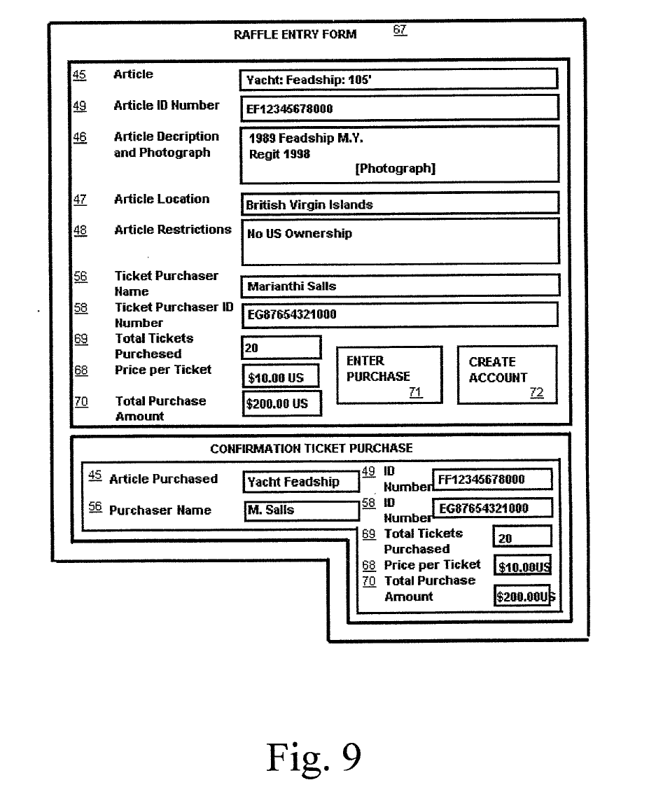

FIG. 9, illustrates a sample raffle entry form 67. Raffle entry form 67 includes ten fields corresponding to article 45 with an example; article identification number 49 with an example; article description and photograph with an example and it is a preferred embodiment to show a photograph, graphical picture and/or a video image of the article; article location 47 with an example; article restrictions 48 with an example; ticket purchaser name 56 with an example; ticket purchaser identification number 58 with an example; total tickets purchased 69 with an example; price per ticket 68 with an example; total purchase amount 70 with an example. Raffle entry form 67 also includes an enter purchase button 71 which permits the ticket purchaser to enter all the information and make the purchase, or the ticket purchaser can access the create account button 72 and create an account if previously not created. Raffle entry form 67 contains a confirmation ticket purchase message 73 with all the relevant information pertaining to the ticket purchase.

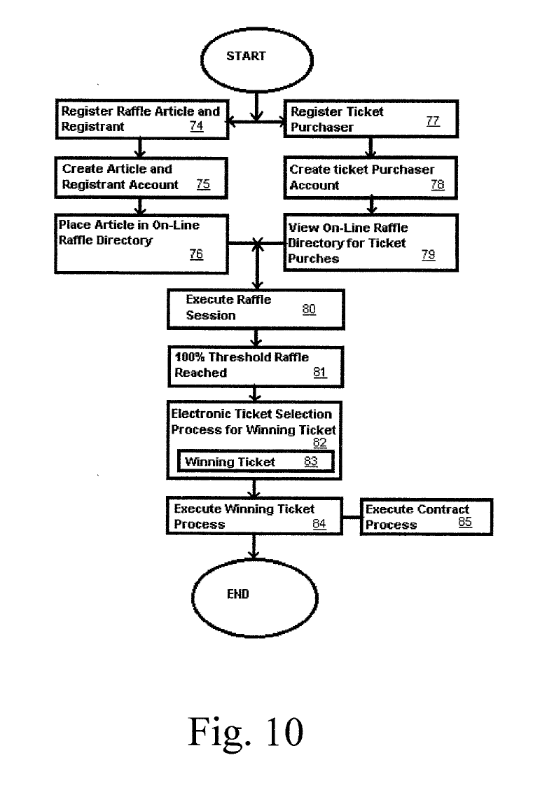

FIGS. 10 through 14 illustrate the operation of the preferred embodiment in flow charts illustrating the overall flow a preferred method for conducting an on-line raffle session according to the present invention.

FIG. 10, illustrates a flow chart listing the overall flow for conducting an on-line raffle session. Step 74 includes the registration of the raffle article and the registrant. The registrant submits an article for raffling for various reasons, in particular, to receive full price for his article instead of having to pay a commission from the sale of the article. Step 74 includes creating an article and registrant account for registering and tracing the article. Step 76, includes placing the article in the on-line raffle directory for review and to begin the raffle session. Step 77, simultaneously or thereafter, of step 74, an interested individual or entity registers as a ticket purchaser and creates a ticket purchaser account, step 78 and at any time the ticket purchaser can view the on-line raffle directory to find the article the ticket purchaser wants to purchase a ticket for, step 79. The preferred embodiment would be for a ticket purchaser to view the on-line directory and be able to view the article through a photograph, graphical picture and/or a video image which could allow a ticket purchaser to take a virtual tour of the article. After the ticket purchaser views the directory and makes their choice of what article or articles the ticket purchaser intends to purchase tickets for, the raffle session is executed, step 80 and when 100% threshold raffle price is reached, step 81 the raffle closes and the ticket numbers are transferred to an electronic ticket selector process for winning ticket selection, step 82 and selects a winning ticket, step 83. After the winning ticket selection the execution of the winning ticket process, step 84 begins, with notification of the winner, transferring the article to the winner and the execution of the contract process, step 85 begins where the article registrant's contract is executed and the registrant receives full payment for the article submitted and raffled.

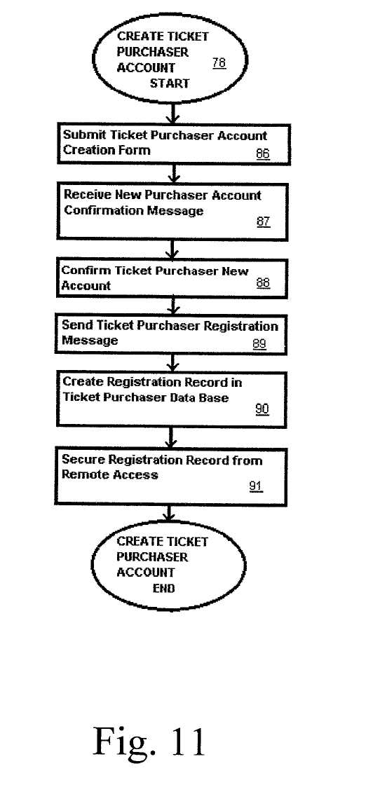

FIG. 11, illustrates a flow chart of step 78 of FIG. 10. Create ticket purchaser account 78 starts with submitting a ticket purchaser account creation form, step 86 by the ticket purchaser going on-line from a remote computer, wherein, the remote computer browser allows the ticket purchaser to access the account creation computer to retrieve the account creation form. after the ticket purchaser opens the account, the ticket purchaser receives a new ticket purchaser account confirmation message, step 87. The ticket purchaser then confirms all the information on the new account, step 89 and the main computer which creates a registration record in the ticket purchaser data base, step 90. The record is secured from remote access, step 91 to prevent any remote access of a ticket purchaser account without the proper identification number.

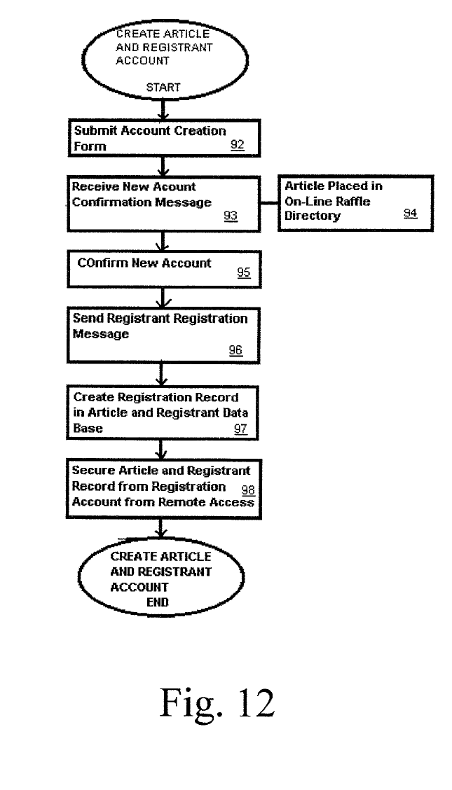

FIG. 12, illustrates a flow chart of step 75 in FIG. 10. Create article and registrant account 75 begins with the registrant going on-line from a remote computer, wherein, the remote computer browser allows registrant to access the account creation computer and retrieve an account creation form. After retrieving the account creation form registrant submits the account creation form, step 92 and receives a new account confirmation message, step 93. The article is then placed simultaneously, in the on-line raffle directory, step 94 so it can be viewed by ticket purchasers. Registrant then confirms the new account, step 95 and receives a registration message, step 96 from the central computer. The central computer creates a registration record in the article and registrant data base, step 97. The article and registrant record is then secured from remote access by remote viewers, step 98 to prevent any remote unauthorized access to article and registrant account information.

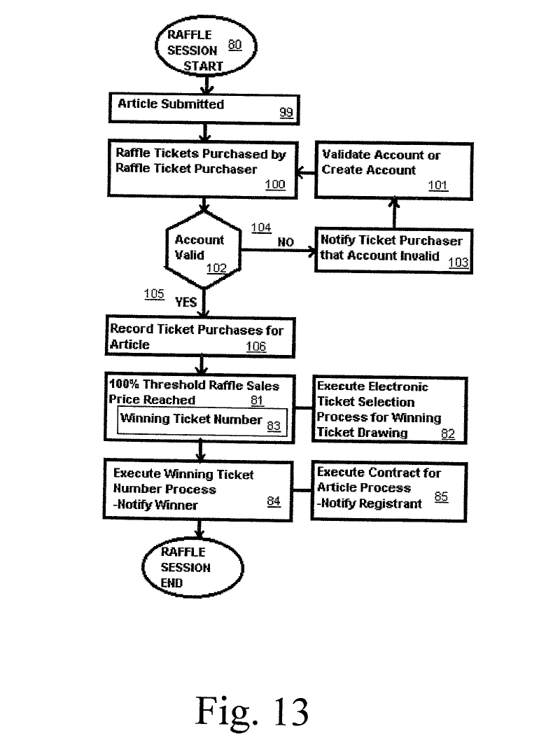

FIG. 13, illustrates a flow chart of step 80 of FIG. 10. The raffle session begins with the submitted article, step 99 which has been registered and entered into the on-line raffle directory. Ticket purchasers purchase tickets, step 100 and determine whether the account is valid. The query results indicate is a ticket purchaser has a valid account, step 102. If the answer is NO,-step 104 the central computer executes step 103, and notifies the ticket purchaser that the account is invalid. The ticket purchaser then validates his account or creates a new account, step 101. The ticket purchaser may have failed to add sufficient funds to the account or needs to create a new account. After validation or creation of a new account, the raffle ticket purchaser retries to purchase tickets again, step 100. If the ticket purchaser account is valid and is indicated by a YES, step 105 the ticket purchase is recorded and matched to a particular article, step 106. After the 100% raffle price threshold is reached, step 81 and a winning ticket is selected, step 83, the winning ticket number process is executed and the winner is notified, step 84, and the article is transferred to the winner. Simultaneously, the contract for the article process is executed and the registrant is notified and paid full price for the article raffled.

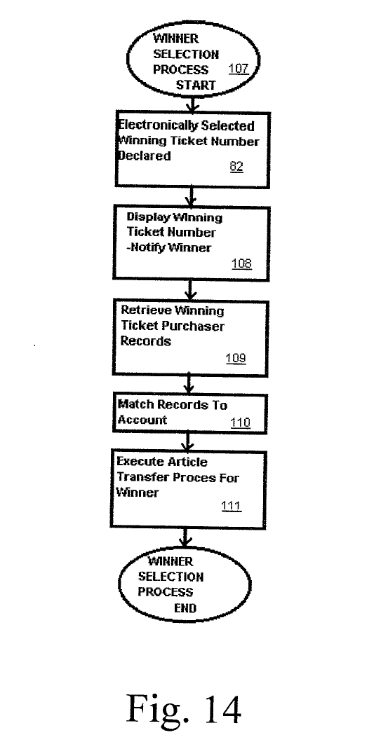

FIG. 14, illustrates a flow chart of winning selection process, step 107 which begins with electronic selection of the winning ticket number and declaring a winner, step 82, and displaying the winning ticket number on-line and notifying the winner of the article, step 108. After notification of the winner the records are retrieved and matched with the results of the selection of the winning ticket, step 110. After confirmation, the article transfer-process is executed for the winner, step 111. The winner receives the article and the registrant is paid in full for the article.

### SUMMARY, REMIFICATIONS, AND SCOPE

Although the above description contains many specificities, these should not be construed as limiting the scope of the invention, but merely as illustrating the presently preferred embodiment. Many other embodiments of the invention are possible. For example, the method for conducting an on-line raffle session according to the present invention need not be used exclusively for submitting articles to the on-line raffle company. The entire process can be accomplished by using the mail or carrier service, where the article owner submits all the required information necessary for submitting an article for raffle. The ticket purchaser process and ticket purchase could be conducted entirely by telephone, facsimile, or wire service.

Therefore, the scope of the invention should be determined by the appended claims and their legal equivalents.

What is claimed is:

1: A raffle computer for conducting an on-line raffle session, said computer being coupled to a plurality of remote computers accross a computer network; said computer comprising:
a. one or more processors;
b. a data base for storing previously registered plurality of articles and registrants;
c. a data base for storing previously registered plurality of raffle ticket purchasers;
d. a communication component for receiving said plurality of articles and registrants registration from said plurality of remote computers and sending the received articles and registrants registration to said processor;
e. wherein, said processor receiving said plurality of articles and registrants registration, categorizes a plurality of articles into a raffle directory;
f. a communication component for receiving said plurality of raffle ticket purchasers from said plurality of remote computers and sending the raffle ticket purchases to said processor;
g. wherein, said processor determines each raffle ticket purchase for each article and stores the determined totals in said raffle ticket purchaser data base;
h. wherein, after a threshold number of sold raffle tickets is reached, a winning raffle ticket number is selected and matched to said raffle ticket purchaser data base to declare a winner.

2: The computer of claim 1, wherein said processor creates registration records in said plurality of articles and registrants data base, wherein, each registration record corresponds to an article and registrant account created by registrants using said remote computers, wherein, each article and registrant account comprises, an article, an article identification number, a registrant name, and a registrant identification number.

3: The computer of claim 1, wherein said processor creates registration records in said plurality of raffle ticket purchasers data base, wherein each registration record corresponds to a raffle ticket purchaser account created by raffle ticket purchasers using said remote computers, wherein each raffle ticket purchaser account comprises a purchaser name, a purchaser address, a purchaser identification number, and a financial account identification number.

4: The computer of claim 3, wherein said communication component receives, with each raffle ticket purchase, the name and identification of the raffle ticket purchaser who purchases a raffle ticket, and said processor verifies if the name and identification number match said registration record stored in said raffle ticket purchaser data base, and records the ticket purchase record in the data base if the name and identification numbers have a verified match.

5: The computer of claim 4, wherein said processor determines if the determined total raffle ticket purchases exceeds a threshold number of tickets to be sold for said article, if the determined total exceeds a threshold number of tickets sold said processor:
a. declares the raffle session, for said article closed;
b. sends the total ticket numbers sold to a winning ticket number selector;
c. determines a winning ticket number by selection means;
d. retrieves the recorded ticket purchases records for said article;
e. determines said raffle ticket purchaser account that corresponds to the retrieved ticket purchase number record; and
f. notifies the raffle ticket purchaser that they have won the article raffled.

6: The computer of claim 1, wherein after said processor updates a total number of said raffle ticket purchases associated with a said article, said processor sends said updated total number or raffle ticket purchases associated with the article through said communication component and said computer network to said plurality of remote computers associated with the article and raffle ticket purchaser.

7: The computer of claim 5, wherein said updated ticket numbers are sent as percentages instead of actual number of raffle tickets sold in order to keep the updated total number of raffle tickets sold confidential.
